(19) United States
(12) Patent Application Publication
(10) Pub. No.: US 2017/0352061 A1
(43) Pub. Date: Dec. 7, 2017

(54) OPTIMAL SOCIAL NETWORK AD ALLOCATION USING HYPERBOLIC EMBEDDING

(71) Applicant: UNIVERSITY OF MARYLAND, COLLEGE PARK, College Park, MD (US)

(72) Inventors: John S. BARAS, Potomac, MD (US); Peixin GAO, Hyattsville, MD (US); Hui MIAO, Takoma Park, MD (US); Mohammad HAJIAGHAYI, Bethesda, MD (US)

(21) Appl. No.: 15/614,302

(22) Filed: Jun. 5, 2017

Related U.S. Application Data
(60) Provisional application No. 62/345,565, filed on Jun. 3, 2016.

(51) Int. Cl. G06Q 30/02; G06Q 50/00

(52) U.S. Cl. CPC G06Q 30/0269; G06Q 50/01

(57) ABSTRACT

Various computational systems may benefit from improvement in determining optimal allocation. For example certain social network advertisement systems may benefit from the use of hyperbolic embedding. A method, according to certain embodiments, can include obtaining a group of users as potential advertising targets. The method can also include mapping the group of users to a hyperbolic space. The method can further include expressing sets of users from the group of users as continuous subsets of the hyperbolic space. The method can additionally include determining influence for the expressed sets of users as sets. The method can also include allocating one or more of the sets to an advertising campaign based on the determined influence.

### CROSS-REFERENCE TO RELATED APPLICATION

This application is related as a non-provisional to and claims the benefit and priority of U.S. Provisional Patent Application No. 62/345,565 filed Jun. 3, 2016, the entirety of which is hereby incorporated herein by reference.

### GOVERNMENT LICENSE RIGHTS

This invention was made with government support under FA95501010573 awarded by AFOSR, CNS1018346 awarded by NSF, CNS1035655 awarded by NSF, 70NANB11H148 awarded by NIST, and H9823014C0137 awarded by NSA. The government has certain rights in the invention.

### BACKGROUND

### Field

Various computational systems may benefit from improvement in determining optimal allocation. For example certain social network advertisement systems may benefit from the use of hyperbolic embedding.

### Description of the Related Art

Social network sites (SNS) such as Facebook, Google+ and Twitter have attracted hundreds of millions of daily users since their appearance. In modern SNS, users expose many personal behaviors and connect to each other based on real world relationships, which makes SNS ideal for targeted advertising.

SNS advertising has grown rapidly in the past years, for example, Facebook has more than 1 million advertisers and 100 billion hits per day. To perform a marketing campaign in an SNS such as Facebook, an advertiser first finds an agent (typically the SNS site), chooses the target audience by specifying desirable user profiles and provides its advertisements (ads) with a bidding price and a budget. Then the agent allocates the ads to the set of users whose profiles match its targeting request.

For each impression (for example, page view) of a user, the agent chooses one or several ads whose target audience include the user. Now the user can see and engage with the ad, for example ‘like’ in Facebook, and then the user's friends may see the ad and further engage. For advertising campaigns, instead of keywords, advertisers bid for a target group of users' actions, which can be mille impressions (cost per thousand impressions), engagements (for example, click or retweet), or actions (for example, app installation or product purchase).

The agent runs large auctions using the bids and charge advertisers by the user actions. There are associated billing policies, such as pay-per-mille, pay-per-click, pay-per-action, pay-per-engagement. The pay-per-mille is the default and most popular policy in Facebook, and this is taken as a non-limiting example throughout this discussion.

The SNS ad allocation problem of maximizing the agent's revenue by allocating ads to user impressions while respecting the advertisers' requests (targeting, bidding, and budget constraint), is a central issue for advertising agents. The concept of paid social influence distinguishes the problem from standard ad allocation and influence maximization problems.

In a situation like AdWords, advertisers bid on search query keywords. In influence maximization, the purchaser only pays the best initial user set of size N to maximize the total users the purchaser can reach by cascading. By contrast, in SNS cases, they bid on users. Moreover, in view of the substantial role of information diffusion in SNS, the users allocated to a particular ad may be allowed to engage with the ad and diffuse it to their neighbors, while advertisers pay for all the impressions.

Different from search engine setting, in the SNS setting, instead of keywords, each advertiser bids for a target group of users, where the impression of the user is by no means of unit value, and is no longer ad-hoc. Consider a user engaging with the Ad (for example, a “like” in Facebook). The user's friends in the user's ego-network can see the Ad and potentially engage with it as well. Without considering the social influence in the Ad allocation, one can easily exceed advertisers' budgets and waste valuable user impressions.

Furthermore, the advertising platform needs to define and consider the domain constraints of the Ad allocation to advertisers. For example, there can be a constraint on fairness (in which users allocated to advertisers have similar influence distributions), or asking higher price for more influential users.

A classic and intuitive approach to tackle the SNS Ad allocation problem is to formulate it as an integer programming (IP) problem, which has two disadvantages. First, the decision variable representing the allocation profile is defined in N^{|A|×|V|} with A the advertiser set and V the user set, which makes it less efficient in large-scale problems. Second, the domain constraints, such as allocating all advertisers the same user influence distribution, are hard to describe.

### SUMMARY

According to certain embodiments, a method can include obtaining a group of users as potential advertising targets. The method can also include mapping the group of users to a hyperbolic space. The method can further include expressing sets of users from the group of users as continuous subsets of the hyperbolic space. The method can additionally include determining influence for the expressed sets of users as sets. The method can also include allocating one or more of the sets to an advertising campaign based on the determined influence.

In certain embodiments, an apparatus can include at least one processor and at least one memory including computer program instructions. The at least one memory and the computer program instructions can be configured to, with the at least one processor, cause the apparatus at least to obtain a group of users as potential advertising targets. The at least one memory and the computer program instructions can also be configured to, with the at least one processor, cause the apparatus at least to map the group of users to a hyperbolic space. The at least one memory and the computer program instructions can further be configured to, with the at least one processor, cause the apparatus at least to express sets of users from the group of users as continuous subsets of the hyperbolic space. The at least one memory and the computer program instructions can additionally be configured to, with the at least one processor, cause the apparatus at least to determine influence for the expressed sets of users as sets. The at least one memory and the computer program instructions can also be configured to, with the at least one processor, cause the apparatus at least to allocate one or more of the sets to an advertising campaign based on the determined influence.

A non-transitory computer-readable medium can, according to certain embodiments, be encoded with instructions that, when executed in hardware, perform a process. The process can include obtaining a group of users as potential advertising targets. The process can also include mapping the group of users to a hyperbolic space. The process can further include expressing sets of users from the group of users as continuous subsets of the hyperbolic space. The process can additionally include determining influence for the expressed sets of users as sets. The process can also include allocating one or more of the sets to an advertising campaign based on the determined influence.

### BRIEF DESCRIPTION OF THE DRAWINGS

For proper understanding of the invention, reference should be made to the accompanying drawings, wherein:

FIG. 1 illustrates isolate cubes and degree spectrum according to certain embodiments of the present invention.

FIG. 2 illustrates an embedding algorithm, according to certain embodiments of the present invention.

FIG. 3 illustrates a method according to certain embodiments of the present invention.

FIG. 4 illustrates a system according to certain embodiments of the present invention.

### DETAILED DESCRIPTION

How to allocate the impressions of users to a set of advertisers with bid constraints while considering the social influence as well as domain constraints at the same time was not well studied. By contrast certain embodiments of the present invention address a homogeneous setting, where all advertisers bid on the same group of users, for example on the whole set of SNS users.

Furthermore, certain embodiments provide a novel formulation by mapping a network to a hyperbolic plane, which may improve the offline run time for the problem. By doing so, certain embodiments may approximate the large scale user-wise calculations with region-wise integrals, changing the discrete domain to a continuous domain. This change may permit description of the allocation strategy using a 2-D geometry shape and may reduce the dimensionality, in the in the order of 0 (V).

On the other hand, region-wise Ad allocation is a convenient framework for representing and visualizing domain constraints. The optimization process is further developed in certain embodiments by using impression decomposition that divides the problem into a series of smaller and simpler ones without introducing strong assumptions. Moreover, certain embodiments provide different allocation strategies, which may have various implications to domain constraints.

Certain embodiments address SNS advertising business models, formulate the SNS ad allocation problem, and show their connections with hyperbolic embedding. Certain embodiments more particularly provide a new embedding algorithm sometimes referred to as HyperCubeMap, which allows for dimension reduction. The method of certain embodiments reduces the dimensionality of the original problem significantly, runs two to four orders of magnitude faster, and reaches 90 or 95% of the optimum. Thus, certain embodiments may improve the performance of a computer running a solution to an SNS ad allocation problem.

To formulate the SNS ad allocation problem, let A denote the set of advertisers, and let U denote the set of users. Each user uεU has a daily impression Iᵤ, and a social influence function P(u). Each advertiser AᵢεA has a target user group t₂⊂U defined by user attributes, a budget bᵢ and bidding price pᵢ. Without losing generality, each advertiser can be assumed to have only one ad, and on a user's one impression it can be assumed that only one ad is displayed in the sponsor pane. In the news feed, the user's friends' ad engagement can be treated as common friends' updates and displayed anyway.

The solution of the allocation problem can decide for each ad what is the initial set of users to be displayed by considering their influence capability. The decision variable can be XεN₀^{|A|×|U|}. For each u and Aᵢ, one dimension of the decision variable x_{u,i} represents how many impressions of u are to be assigned to Aᵢ. The optimization problem can be to find the allocation that maximizes the agent's total revenue. As mentioned above, one solution is to address this as an integer program.

However, the decision variable XεN₀^{|A|×|U|} lies in high dimension, for example, as much as 10¹⁶, when considering 1 million advertisers and billion users daily in Facebook. This makes the direct optimization impractical. To make such optimization more tractable, or for other purposes, certain embodiments provide an approximation scheme, referred to for convenience as HyperCubeMap.

Certain embodiments of the present invention can exploit the target group concept in the problem by using hyperbolic embedding. Notice that in an advertiser Aᵢ's target group tᵢ, all users are considered the same by the ad, the only difference is their influence capabilities. If the user impression allocation for Aᵢ and revenue calculation with influence on the target can be approximated on the group level rather than the user level, certain embodiments may be able to eliminate several orders of magnitude of dimensions for the problem. For 10⁹ users and 10^{3˜6} categories in a real world SNS such as Facebook, for example, the dimension can be reduced to around 10^{3˜6}.

Hyperbolic embedding can refer to a geometric mapping from a complex network G (V,E) to a set of points and segments in a hyperbolic space D. The hyperbolic space can be continuous. Hyperbolic embedding can map arbitrary size complex networks into a bounded area where each node is assigned a coordinate.

If SNS is embedded properly, regions in the hyperbolic space can be used to express a set of users allocated to an ad. Then, the revenue from Aᵢ can be approximated as an integral of the user's influence function over a certain region Rᵢ⊂D:

$${p}_{i} {\sum }_{u ∈ {t}_{i}}^{ } {x}_{u , i} ( 1 + P ( u ) ) ≅ {p}_{i} {\int }_{r}^{ } {\int }_{θ}^{ } I ( {R}_{i} ( r , θ ) ) d θ dr$$

As a small number of variables can be used to describe a set of users assigned to Aᵢ with regular shapes such as fan and ring, the dimensions of the original problem can be reduced significantly.

Hyperbolic space is a non-Euclidean geometrically smooth space that generalizes the idea of Riemannian manifolds with negative curvature. In certain embodiments described herein, a Poincaré disc model, D={zε [symbol] ∥Z|<1}. The connection between the complex network and the hyperbolic space can lie in the Gromov's δ-hyperbolicity of a metric space. Power law degree distributions and strong clustering in complex networks can be viewed as reflection of the negative curvature property of the underlying hyperbolic geometry. Thus, a mapping can be designed between hyperbolic space and complex networks, which can accommodate arbitrary size network and can successfully capture important features in complex networks, such as small world effect, scale-free and community structure.

Advertisers may bid on heterogeneous user groups, and users may have different impressions and influence capability. Thus, to apply the embeded SNS for dimension reduction via integration, the hyperbolic embedding may have the following properties: both the node density and degree distribution can be well-defined along angular and radial axes to support integrals; the social influence function defined on the user's coordinate (r, θ) can be continuous on the Poincaré disc D, otherwise the column with the related surface may not be integrable; and the embedding method can embed users within the same targeting group onto connected regions. Otherwise, a user group can be described by a collection of discrete points and dimension reduction may not be achieved.

The HyperCubeMap embedding algorithm can have the three above-described properties. This algorithm can first ensure the node density and degree are well-defined along the radial axis: node density can be defined by ρ(r)=ae^{τ} and degree distribution can be defined by ω(r)=ce^{-r/2}, where a and c are constants derived from embedding.

The algorithm can then organize the Poincaré disc into dimension reduction feasible cubes and calculate the minimal set of groups to boost dimension reduction effectiveness. An example of the whole embedding algorithm which satisfies all three prerequisites is also provided below. To improve precision and ease tuning, uniform node density embedding, as further discussed below.

To let the advertisers specify the target user group, the agent often provides a set of category filters, each of which has fixed number of options. In Facebook's case, there are seven major user attributes for filtering: for example, location, gender, age, language, and interests. The target user group of a campaign is the selection of given options. The size of option profiles is not very large, for example Facebook has common option profiles bounded by 10⁶ and discourages too fine-grained filters by giving warnings.

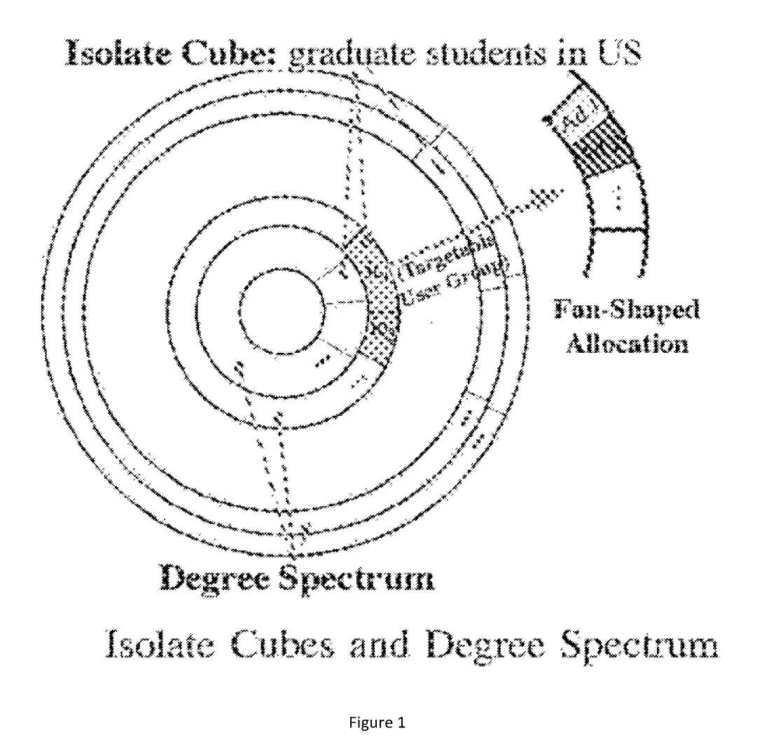

To capture these aspects or for other reasons, certain embodiments provide for an isolate cube to express user groupings, and for degree spectrum to divide the Poincaré disc into finer and more regular shapes which may ease the calculation and improve the precision, as shown in FIG. 1.

FIG. 1 illustrates isolate cubes and degree spectrum according to certain embodiments of the present invention. As shown in FIG. 1, the isolate cubes may be, for example, graduate students in the US. Moreover, there can be various degree spectra. A targetable user group may be, for example, a fan shaped allocation from the Poincaré disc.

An isolate cube can be a set of unit targetable user groups having the same set of campaigns. Users in the same isolate cube can be shared by the same set of campaigns. Any two users in an isolate cube can be interchangeable in an allocation solution. As the isolate cubes are related to dimension reduction performance, the fewer isolate cubes there are, the better performance can benefit from the embedding. In the worst case, considering the ad platform that defines F categorical filters, and each ƒεF has v_{ƒ} distinct options, there may be at most Π_{ƒεF} v_{ƒ} isolate cubes.

As one can envision, the population in each user group may vary a lot, as may the degree distributions in each of them. During embedding, different isolate cube can result in very different shapes in a Poincaré disc. To make the embedding useful and ensure accuracy (or for other reasons), degree spectrum can be used to regularize the embedding shape.

A degree spectrum, A, can be a series of annuli centered at (0,0) on 2-D Poincaré disc. Each annulus λεΛ with radius (rₛ, rₑ), represents all the users with degree in the range of ω(rₛ),ω(rₑ). As shown in FIG. 1, the annuli are the degree spectrum.

Within each annulus, isolate cubes can be allocated in fans whose area is proportional to the number of users in an isolate cube. Each advertiser Aᵢ can target a set of isolate cubes, IC₁, each of which has locations in some or all annuli in the spectrum Λ. Thus, the allocation can be represented by at most |ICᵢ|·|Λ| dimensions for Aᵢ. Note that |Λ| can be a tuning parameter of certain embodiments of the present invention can be tuned by fixing the degree range d. In an extreme case, d=1, each annulus only contains the users with the same degree.

As the size of isolate cubes may be important for dimension reduction performance, certain embodiments may determine a minimal set of isolate cubes. Assume the ad platform designs a set of filters F, where each ƒεF has a set of possible values, v. Each advertiser Aᵢ can select targeting values (ƒ, vᵢ) for each filter, denoted by Oᵢ={(ƒ, vᵢ)|ƒεF}, which defines a set of target users Tᵢ={u|ƒ, vᵢ)εOᵢ, u[ƒ]εvᵢ}. Given all advertisers A and their targeting profiles O, the target users can be clustered together and the optimal isolate cubes (opt_ic) can be derived to provide the smallest set of isolate cubes, while providing the best dimension reduction performance.

A hashing based approach can be used to derive the opt_ic in O(O) time. By scanning O, for each filter value (ƒ,vᵢ), a signature can be built based on the set of advertisers that bid it. Then all (ƒ,vᵢ) can be scanned, and those that share the same signature can get the opt_ic.

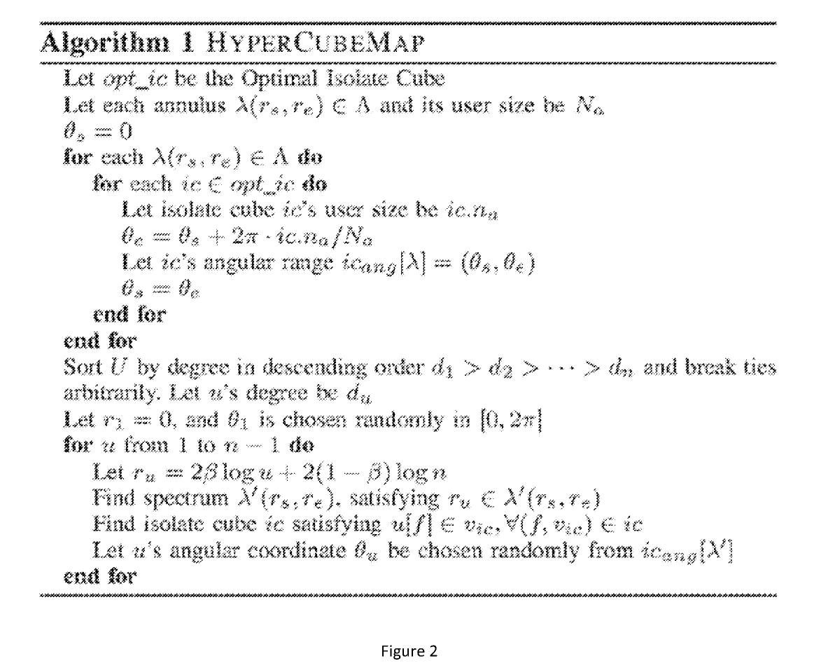

FIG. 2 illustrates an embedding algorithm, according to certain embodiments of the present invention. This algorithm can be referred to as HyperCubeMap, as discussed above. Given and SNS G(U, E), advertisers A, targeting profile O, and spectrum design Λ, the algorithm can place each user uεU u E U to (rᵤ, θᵤ). The algorithm can first generate the optimal isolate cubes opt_ic, and then for each spectrum annulus λ(rₛ, rₑ)A(·rs, re), it can assign each icεopt_ic an angular coordinate range (θₛ, θₑ).

To ensure the uniform node density along angular axis, the range can be proportional to the ic's target user size portion in this spectrum annulus. To ensure the same targetable user groups are allocated together, the angular coordinate of each user can be assigned in its associated isolate cube ic. β is a mitigating factor determined by the power law exponent γ:

$$β = \frac{1}{γ} ;$$

γ can be found for a given network. The algorithm complexity can be linear, given users sorted by degree.

HyperCubeMap can produce an embedding that satisfies the prerequisites discussed above. On the Poincaré disc, the degree distribution and node density may be well defined along angular and radial axes, node density ρ(r)=ae^{τ}, and correspondingly expected degree ω(r)=ce^{-r/2}, rε[0, R]. The same targeted group users can be embedded into connected regions. With a continuous social influence function, the problem can be reformulated to a region allocation problem with many fewer dimensions than in an alternative approach.

From Algorithm 1 in FIG. 2, it can be seen that the inner area of the Poincaré disc may be very sparse due to the exponential node density along the radius, which affects the optimality of approximation and presents a challenge for parameter tuning and allocation scheme design.

Thus, node density can be adjusted to make node density uniform along the radius, by moving nodes inside as an alternative embedding method.

For a point at (r, θ) by Algorithm 1, the point's new coordinate can be (r′, θ), then the uniform density function ρ′(r′) can be derived as follows:

$${ρ}^{′ ( {r}^{′} )} = \frac{{\int }_{0}^{R} {\int }_{0}^{2 π} ρ ( τ ) d θ d τ}{π {R}^{2}} = \frac{2 a ( {e}^{R} - 1 )}{{R}^{2}}$$

The mapping ψ(r) from r to r′ can be as follows:

$${r}^{′} = ψ ( r ) = \sqrt{{R}^{2} \cdot \frac{( {e}^{τ} - 1 )}{( {e}^{R} - 1 )}} = R \sqrt{\frac{{e}^{τ} - 1}{{e}^{R} - 1}}$$

Thus, the expected degree at new coordinate (r′, θ) can be expressed as follows:

$${{ω}^{′} ( {r}^{′} ) = ω ( r ) \vert}_{r = {ψ}^{- 1} ( {r}^{′} )} = \frac{cR}{\sqrt{{τ}^{′2} {e}^{R} - {τ}^{′2} + {R}^{2}}}$$

Using HyperCubeMap, the ad allocation problem can reformulated as a region allocation problem on the 2-D Poincaré disc D. On D, each user uεU with impression degree IᵤεI can be placed at (rᵤ, θᵤ) in polar coordinates with an expected set of advertisers A, each AᵢεA has a budget b, and bidding price pᵢpi on a set of bidding isolate cubes of target users denoted as Tᵢ={ic₁, ic₂, . . . , icₙ}. T=∪Tᵢ can be the optimal isolate cubes (opt_ic). Given the degree spectrum Λ, the allocation profile for Aᵢ can be defined as Sᵢ={Sᵢ^{λ,c}|λεΛ, cεT}, where λ denotes the annulus, c specifies the isolate cube, Sᵢ is a set of fans {θ_{i,s}^{λ,c}, θ_{i,e}^{λ,c}}, each of which describes how to allocate users in an isolate cube c on a degree spectrum annulus λ. The optimal region allocation problem can be to derive an allocation profile S for A to maximize the revenue of the agent while respecting the budget and impression constraints:

$${max}_{S} {\sum }_{{A}_{i} ∈ A}^{ } {p}_{i} {f}_{i} ( S , I )$$

Subject to Sᵢ⊂Tᵢ ∀AᵢεA

0≦pᵢƒᵢ(S,I)≦bᵢ ∀AᵢεA

φᵤ(S,I)=Σ_{S}_{ᵢ}_{εS}φᵤ(Sᵢ,I)≦Iᵤ ∀uεU

θₑ^{λ,c}≧θ_{i,e}^{λ,c}≧θ_{i,s}^{λ,c}≧θₛ^{λ,c} ∀cεT,λεΛ

where ƒᵢ (S,I) is Aᵢ's actual sum of impressions considering social influence. φᵤ(S,I) is u's impressions assigned to Aᵢ. Now a set of users may have beem assembled as a fan shape on the Poincaré disc, which may significantly reduce dimensions.

On the other hand, angular coordinates are continuous values instead of discrete values as before. If closed forms are given for each ad Aᵢ's assigned impressions ƒᵢ(S,I) and each user u's allocated impression φᵤ(S,I), then the problem can be solved directly. In order to do so, it may be useful to specify how to incorporate with social influence, and address two challenges: the impression distribution may not be well-defined and uncorrelated with degree; and overlapping fans. The first issue may prevent the application of an integral, while the second issue may make optimization more complicated.

The actual impressions resulting from user u may be different from Iᵤ due to the user's social influence in the network. All exposed qualified impressions can have a cost to the advertiser. Thus, the actual profit of the agent may be as follows:

pᵢ·Iᵤ·(1+P(u))

As discussed above, u's influence function P(u) can be defined using its 1-hop degree. After applying hyperbolic embedding, the influence function of user u can be as follows:

P(u)=P(rᵤ,θᵤ)=w·dᵤ=w·w(rᵤ,θᵤ)=w·ce^{-r}^{ᵤ}^{/2}

where w is a constant representing the engagement rate. Under uniform node density, the influence function P′(u) can be as follow:

$${P}^{′} ( u ) = P ( {r}_{u}^{′} , {θ}_{u}^{′} ) = w \cdot \frac{cR}{\sqrt{{τ′}^{2} {e}^{R} - {τ}^{′2} + {R}^{2}}}$$

which are both continuous functions, and can be used in integral to express ƒᵢ(S,I) over the Poincaré disc.

The unknown user impression distribution in the hyperbolic embedding of the SNS may significantly affect the formulation. Complex region intersection may not have an analytical expression or convexity. Also, the unknown impression distribution forces discretization of ƒᵢ and inevitably increases the complexity. To address these issues without introducing strong assumptions (for example, disallow overlapping, enforce well-defined impression distributions, or the like), certain embodiments can extend a unit impression decomposition optimization framework.

Certain embodiments may decompose the SNS into a series subgraphs where uεU has an impression Iᵤ=1, so there cannot be any intersections where one impression would be shared by multiple advertisers. A sub step optimization can be conducted in each subgraph by adding a non-overlap constraint. Moreover, ƒᵢ(S,I) can he formulated as ƒᵢ(Sᵢ), as the volume assigned to Aᵢ can be independent.

With unit impression decomposition, the original problem can be solved using a multi-stage optimization process. This process can finish when all impressions are allocated or all budgets are used. In the mth stage, given the unit impression graph G^{(m)}, HyperCubeMap can be applied to embed G^{(m)} in the hyperbolic space. For each advertiser AᵢεA^{(m)} whose budget bᵢ^{m}>0, the sub-step of the optimization problem can be given as follows.

$${max}_{{S}^{( m )}} {\sum }_{{A}_{i} ∈ A}^{ } {p}_{i} {f}_{i} ( {S}_{i}^{( m )} )$$

Subject to Sᵢ^{(m)}⊂Tᵢ^{(m)} ∀AᵢεA^{(m)}

0≦pᵢƒᵢ(Sᵢ^{(m)})≦bᵢ^{(m)} ∀AᵢεA^{(m)}

Sᵢ^{(m)}∩Sⱼ^{(m)}=0 ∀Aᵢ, AⱼεA^{(m)} [symbol] i≠j

U_{A}_{ⁱ}^{A}^{^{(m)}}Sᵢ^{λ,c(m)}⊂S^{λ,c(m)} ∀cεT^{(m)}, λεΛ^{(m)}

The non-overlapping problem stated this way can then be solved, and the optimal solution S^{(m)*} and optimal value Σ_{A}_{ᵢ}_{εA} ƒᵢ(Sᵢ^{(m)*}) can be recorded. The budget vector can be updated as bᵢ^{(m+1)}=bᵢ^{(m)}−pᵢ·ƒᵢ(Sᵢ^{(m)*}), and the m+1^{th} unit impression graph can be generated with residual impressions and removing users with no impression left and their edges. This process can end when all advertisers' budgets are used, or all impressions are exploited.

With exponential node density and degree distribution, the allocation ƒᵢ(Sᵢ^{λ,c}) can be calculated as:

$${f}_{i} ( {S}_{i}^{λ , c} ) = {f}_{i} ( {θ}_{i , s}^{λ , c} , {θ}_{i , e}^{λ , c} ) = {\int }_{{τ}_{e}^{λ}}^{{τ}_{e}^{λ}} {\int }_{{θ}_{i , s}^{λ}}^{{θ}_{i , e}^{λ , c}} ρ ( τ ) ( 1 + P ( τ , θ ) ) d θ d τ = a {\int }_{{τ}_{e}^{λ}}^{{τ}_{e}^{λ}} {e}^{τ} ( 1 + {wce}^{- \frac{τ}{2}} {\int }_{{θ}_{i , s}^{λ}}^{{θ}_{i , e}^{λ , c}} d θ d τ = {Δ}_{λ} {θ}_{i}^{λ , c} \\ where {Δ}_{λ} = a ( 2 {wce}^{\frac{{τ}_{e}^{λ}}{2}} - 2 {wce}^{\frac{{τ}_{s}^{λ}}{2}} + {e}^{{τ}_{s}^{λ}} - {e}^{{τ}_{s}^{λ}} )$$

is a constant related to the annulus λ and θᵢ^{λ,c}=θ_{i,e}^{λ,c}−θ_{i,s}^{λ,c} is the angle range of the region Sᵢ^{λ,c}. Now the function ƒᵢ(Sᵢ^{λ,c}) is actually a linear function of θᵢ^{λ,c}, regardless of its start and end angles.

If we apply the uniform node density transform, the volume ƒᵢ can be calculated with a different boundary (r′ₛ^{λ},r′ₑ^{λ}), then:

$${f}_{i} ( {S}_{i}^{λ , c} ) = {\int }_{{τ′}_{e}^{λ}}^{{τ′}_{e}^{λ}} {\int }_{{θ}_{i , s}^{λ}}^{{θ}_{i , e}^{λ , c}} {ρ}^{′} ( {τ}^{′} ) ( 1 + {P}^{′ ( τ , θ )} ) d θ d {τ}^{′} = {Δ}_{λ}^{′} {θ}_{i}^{λ , c}$$

$$where$$

$${Δ}_{λ}^{′} = a ( 2 wc {e}^{\frac{{ψ}^{- 1} ( {τ′}_{e}^{λ} )}{2}} - 2 wc {e}^{\frac{{ψ}^{- 1} ( {τ′}_{s}^{λ} )}{2}} + {e}^{{ψ}^{- 1} ( {τ′}_{e}^{λ} )} - {e}^{{ψ}^{- 1} ( {τ′}_{s}^{λ} )} )$$

is still a constant related to λ and Λ, and ƒᵢ is linear.

Combining the unit impression decomposition and fan-shaped allocation strategy, the optimal region allocation problem can be elaborated as a linear program:

$${max}_{{Θ}^{( m )}} {\sum }_{{A}_{i} ∈ {A}^{( m )}}^{ } {p}_{i} {\sum }_{λ ∈ Λ}^{ } {Δ}_{λ} {\sum }_{c ∈ {T}_{i}^{( m )}}^{ } {θ}_{i}^{λ , c ( m )}$$

subject to pᵢΣ_{λεΛ}Δ_{λ}Σ_{cεT}_{ᵢ}_{^{(m)}}θᵢ^{λ,c(m)}≦bᵢ^{(m)} ∀AᵢεA^{(m)}

Σ_{A}_{ᵢ}_{εA}_{^{(m)}}θᵢ^{λ,c(m)}≦θₑ^{λ,c(m)} . . . θₛ^{λ,c(m)} ∀cεT^{(m)},λεΛ^{(m)}

where the decision variable Θε [symbol] _{≧0}^{|A|×|A|×|T|}. Δ_{λ} is the constant used above. The uniform node density setting can be derived accordingly, by replacing Δ_{λ} with Δ′_{λ}.

If the optimization stops after n stages, then the allocation of ad Aᵢ is the aggregation of optimal solutions: Uₖ₌₁ⁿ Sᵢ^{(k)*}.

Note that while in one iteration there is no overlap, the final aggregated regions may have overlaps, as each iteration can be based on a different Poincaré disc.

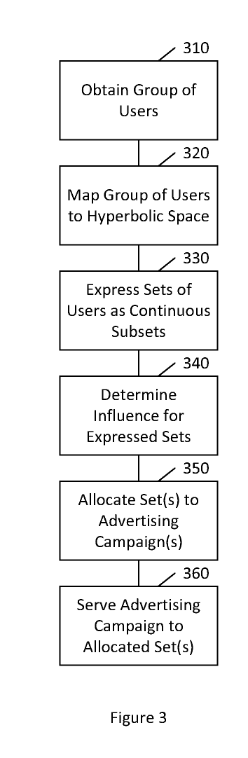

FIG. 3 illustrates a method according to certain embodiments of the present invention. The method of FIG. 3 may be implemented using the HyperCubeMap algorithm or any variation on or substitute therefor, including any of the above-described embodiments.

As shown in FIG. 3, a method can include, at 310, obtaining a group of users as potential advertising targets. This can refer to the process of identifying the group of users from a database, or some other way of obtaining an indication of the users of, for example, a social network.

The method can also include, at 320, mapping the group of users to a hyperbolic space. The mapping the group of users to the hyperbolic space can include uniform node density embedding. The uniform node density embedding can be performed with respect to a Poincaré disk.

The method can further include, at 330, expressing sets of users from the group of users as continuous subsets of the hyperbolic space. The expressing sets of users from the group of users as continuous subsets of the hyperbolic space can include expressing the sets of users as at least one segment of a Poincaré disk selected from a ring, a fan, or a circle.

The method can additionally include, at 340, determining influence for the expressed sets of users as sets. The determining influence for the expressed sets of users as sets can include performing a unit impression decomposition.

The method can also include, at 350, allocating one or more of the sets to an advertising campaign based on the determined influence. In certain embodiments, the method can further include, at 360, serving the advertising campaign to the one or more allocated sets.

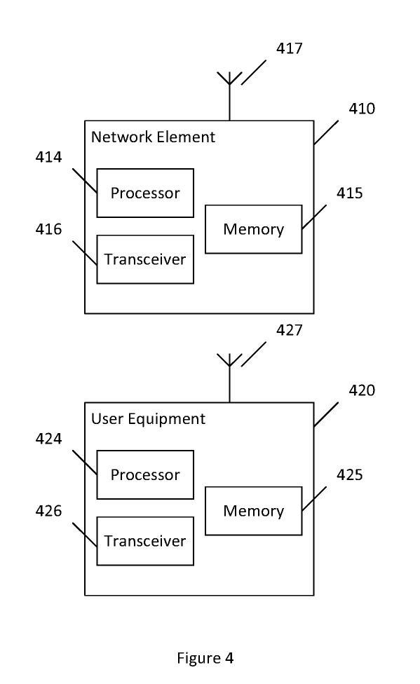

FIG. 4 illustrates a system according to certain embodiments of the invention. It should be understood that each block of the flowchart of FIG. 3 may be implemented by various means or their combinations, such as hardware, software, firmware, one or more processors and/or circuitry. In one embodiment, a system may include several devices, such as, for example, network element 410 and user equipment (UE) or user device 420. The system may include more than one UE 420 and more than one network element 410, although only one of each is shown for the purposes of illustration. A network element can be an access point, a base station, an eNode B (eNB), or any other network element, such as a PCell base station or a PSCell base station. Each of these devices may include at least one processor or control unit or module, respectively indicated as 414 and 424. At least one memory may be provided in each device, and indicated as 415 and 425, respectively. The memory may include computer program instructions or computer code contained therein, for example for carrying out the embodiments described above. One or more transceiver 416 and 426 may be provided, and each device may also include an antenna, respectively illustrated as 417 and 427. Although only one antenna each is shown, many antennas and multiple antenna elements may be provided to each of the devices. Other configurations of these devices, for example, may be provided. For example, network element 410 and UE 420 may be additionally configured for wired communication, in addition to wireless communication, and in such a case antennas 417 and 427 may illustrate any form of communication hardware, without being limited to merely an antenna.

Transceivers 416 and 426 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 420 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof. The user device or user equipment 420 may be a sensor or smart meter, or other device that may usually be configured for a single location.

In an exemplifying embodiment, an apparatus, such as a node or user device, may include means for carrying out embodiments described above in relation to FIG. 3.

Processors 414 and 424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof. The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 415 and 425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 410 and/or UE 420, to perform any of the processes described above (see, for example, FIG. 3). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 4 illustrates a system including a network element 410 and a UE 420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
obtaining a group of users as potential advertising targets;
mapping the group of users to a hyperbolic space;
expressing sets of users from the group of users as continuous subsets of the hyperbolic space;
determining influence for the expressed sets of users as sets; and
allocating one or more of the sets to an advertising campaign based on the determined influence.

2. The method of claim 1, further comprising:
serving the advertising campaign to the one or more allocated sets.

3. The method of claim 1, wherein the determining influence for the expressed sets of users as sets comprises performing a unit impression decomposition.

4. The method of claim 1, wherein the expressing sets of users from the group of users as continuous subsets of the hyperbolic space comprises expressing the sets of users as at least one segment of a Poincaré disk selected from a ring, a fan, or a circle.

5. The method of claim 1, wherein the mapping the group of users to the hyperbolic space comprises uniform node density embedding.

6. The method of claim 5, wherein the uniform node density embedding is performed with respect to a Poincaré disk.

7. An apparatus, comprising:
at least one processor; and
at least one memory including computer program instructions,
wherein the at least one memory and the computer program instructions are configured to, with the at least one processor, cause the apparatus at least to
obtain a group of users as potential advertising targets;
map the group of users to a hyperbolic space;
express sets of users from the group of users as continuous subsets of the hyperbolic space;
determine influence for the expressed sets of users as sets; and
allocate one or more of the sets to an advertising campaign based on the determined influence.

8. The apparatus of claim 7, wherein the at least one memory and the computer program instructions are further configured to, with the at least one processor, cause the apparatus at least to serve the advertising campaign to the one or more allocated sets.

9. The apparatus of claim 7, wherein the determining influence for the expressed sets of users as sets comprises performing a unit impression decomposition.

10. The apparatus of claim 7, wherein the expressing sets of users from the group of users as continuous subsets of the hyperbolic space comprises expressing the sets of users as at least one segment of a Poincaré disk selected from a ring, a fan, or a circle.

11. The apparatus of claim 7, wherein the mapping the group of users to the hyperbolic space comprises uniform node density embedding.

12. The apparatus of claim 11, wherein the uniform node density embedding is performed with respect to a Poincaré disk.

13. A non-transitory computer-readable medium encoded with instructions that, when executed in hardware, perform a process, the process comprising:
obtaining a group of users as potential advertising targets;
mapping the group of users to a hyperbolic space;
expressing sets of users from the group of users as continuous subsets of the hyperbolic space;
determining influence for the expressed sets of users as sets; and
allocating one or more of the sets to an advertising campaign based on the determined influence.

14. The non-transitory computer-readable medium of claim 13, the process further comprising:
serving the advertising campaign to the one or more allocated sets.

15. The non-transitory computer-readable medium of claim 13, wherein the determining influence for the expressed sets of users as sets comprises performing a unit impression decomposition.

16. The non-transitory computer-readable medium of claim 13, wherein the expressing sets of users from the group of users as continuous subsets of the hyperbolic space comprises expressing the sets of users as at least one segment of a Poincaré disk selected from a ring, a fan, or a circle.

17. The non-transitory computer-readable medium of claim 13, wherein the mapping the group of users to the hyperbolic space comprises uniform node density embedding.

18. The non-transitory computer-readable medium of claim 17, wherein the uniform node density embedding is performed with respect to a Poincaré disk.
